(19) United States
(12) Patent Application Publication
(10) Pub. No.: US 2004/0227311 A1
(43) Pub. Date: Nov. 18, 2004

(54) Binding insert suspension system

(75) Inventor: Doug Sanders, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: K-2 Corporation

(21) Appl. No.: 10/438,138

(22) Filed: May 13, 2003

(51) Int. Cl. B62B 9/04

(52) U.S. Cl. 280/14.22

(57) ABSTRACT

A binding insert suspension includes an insert assembly affixed within the core of a snowboard, and a compressible layer disposed between the binding and the snowboard. The insert assembly comprises an outer insert member and an inner insert member slidably seated with the outer insert member. The inner insert member is adapted to receive a threaded fastener of a binding in threaded engagement. The binding insert suspension provides a selected amount of dampened vertical travel between the snowboard and the binding for absorbing vibration when riding hard-packed surfaces, and for providing shock absorption when riding over jumps, half pipes, and other terrain.

### FIELD OF THE INVENTION

The present invention relates generally to glide boards, such as snowboards and skis, and more particularly, to binding insert suspension systems for snowboard.

### BACKGROUND OF THE INVENTION

A snowboarder's boots are typically secured to the snowboard by a binding that has one of a variety of overall configurations depending on intended use and rider preferences. Some riders utilize a conventional binding that includes a rear strap that secures over the rider's instep and a forward strap that secures over the ball or toes of the rider's boot. Other riders utilize a step-in binding system, in which engagement members secured on the boot, typically on a lower or side surface of the sole, selectively engages with jaws or catches on the binding. Numerous variations on these arrangements exist, but in each case the snowboard binding includes a frame or base plate that is fastened to the upper surface of the snowboard. Typically screws are utilized that pass through apertures formed in either the snowboard base plate or in a disc that mounts in the center of the base plate to permit rotatable adjustment of the base plate positioning. The screws are threaded into inserts that are molded, adhered or otherwise affixed within the upper surface of the snowboard. Generally, inserts are T-shaped anchors with internally threaded bores.

As is known in the snowboarding art, it is often desirable to provide a degree of vibration dampening and shock absorption between the binding and the board. Vibration dampening provides for better control, particularly when riding hard packed surfaces, and shock absorption is particularly beneficial for riding over jumps, half pipes, and other terrain. Accordingly, some binding manufacturers have developed bindings that accommodate gasket like elastomeric dampeners disposed between the binding plate and board. Other manufacturers have developed suspension plates and elastomeric pads to be disposed between the binding and the snowboard. Each of these devices function to absorb shock and vibration between the binding plate and board.

However, these devices are not without their disadvantages. For example, the suspension plates are typically tall and heavy. This causes several problems. First, because the suspension plate is tall, the binding is mounted a farther distance away from the snowboard than is typically done, which causes a decrease in board control, force transmission, and responsiveness as the snowboarder moves his/her boots. Additionally, the weight of the suspension plate dramatically increases the overall weight of the combined system, which increases fatigue and decreases performance. Lastly, the suspension plates affect the normal flex characteristics of the snowboard, which alters the overall feel and performance of the snowboard.

With regard to the gasket-like elastomers and elastomeric pads, the compressibility of the layer causes the threaded fasteners to translate upwards into the boot, and loosen the connection between the binding and the snowboard. This may allow the binding to slide relative to the snowboard, which decreases board control force transmission, and responsiveness as the snowboarder moves his/her boots.

Thus, there is a need for an insert system that provides vibration capabilities and overcome the deficiencies in the prior art described above and others. The present invention is directed to such a system.

### SUMMARY OF THE INVENTION

The present invention is directed to an insert for use in a binding insert suspension system and a binding insert suspension system that provides a selected amount of dampened vertical travel between the snowboard and the binding for absorbing vibration when riding hard-packed surfaces, and for providing shock absorption when riding over jumps, half pipes, and other terrain.

In accordance with aspects of the present invention, an insert for a glide board to receive a binding fastener is provided. The glide board has a lower surface. The insert includes an outer member to be mounted within the glide board. The outer member includes a cavity. The insert further includes an inner member disposed within the cavity. The inner member is movable within the cavity about an axis substantially transverse to the lower surface of the glide board while the glide board is in use. The inner member is configured to receive a binding fastener.

In accordance with another aspect of the present invention, a glide board to which a binding is removably secured by at least one binding fastener is provided. The glide board includes a core disposed between top and bottom layers and has at least one bore that extends through the core to form an opening in the top layer. The opening is configured for receiving the binding fastener therein. The glide board also includes an outer insert member disposed within the bore and coupled to at least the core. The outer insert member has a top end and defines a cavity. The glide board further includes an inner insert member disposed within the cavity of the outer insert member. The inner insert member is movable within the cavity for translation along an axis substantially transverse to the longitudinal axis of the glide board. The inner insert member is configured for receiving the binding fastener in removable securement.

In accordance with yet another aspect of the present invention, a glide board having a top surface is provided. The glide board includes at least one bore opening at the top surface. The opening of the bore is configured for receiving a binding fastener therein. The glide board also includes an outer insert member disposed within the bore. The outer insert member includes a cavity and an opening formed by a lip section for permitting access to the cavity. An inner insert member is disposed within the cavity and keyed thereto for permitting translation within the cavity but inhibiting rotation of the inner insert member with respect to the outer insert member. The inner insert member is configured to receive the binding fastener. The glide board further includes a biasing member disposed within the outer insert member cavity that exerts a biasing force against a top end of the inner insert member and the lip section of the outer insert member.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an exploded view of a schematic representation of a conventional snowboard binding adapted to be fixedly secured to the top surface of a snowboard in accordance with the present invention;

FIG. 2 is a partial cross-sectional side view of a binding insert suspension system formed in accordance with the present invention in an uncompressed state;

FIG. 3 is a partial cross-sectional side view of a binding insert suspension system of FIG. 2 in a compressed state;

FIG. 4 is a cross-sectional view of the snowboard of FIG. 2;

FIG. 5 is a cross-sectional view of the insert assembly of the suspension system of FIG. 2;

FIG. 6 is an alternative embodiment of a suspension system formed in accordance with the present invention;

FIG. 7 is an alternative embodiment of a suspension system formed in accordance with the present invention;

FIG. 8 is an alternative embodiment of a suspension system formed in accordance with the present invention;

FIG. 9 is an alternative embodiment of a suspension system formed in accordance with the present invention; and

FIG. 10 is an alternative embodiment of a suspension system formed in accordance with the present invention.

### DETAILED DESCRIPTION OF THE PREFERRED EMBODIMENT

The present invention will now be described with reference to the accompanying drawings where like numerals correspond to like elements. The present invention is directed to a binding insert suspension system, which facilitates the secured attachment of a binding to a glide board. More specifically, the present invention is directed to a binding insert suspension system that fixedly secures a snowboard binding to a snowboard, while providing shock and vibration absorption capabilities for increasing the overall comfort, performance, and enjoyment for the rider during use. While the binding insert suspension system is described herein for use with a snowboard, it will be appreciated that the binding insert suspension system may be practiced with other glide boards or surface traversing apparatuses, such as snow skis, water skis, wakeboards, and snowshoes. Thus, the following description relating to snowboard bindings and snowboards is meant to be illustrative and not limiting the broadest scope of the inventions, as claimed.

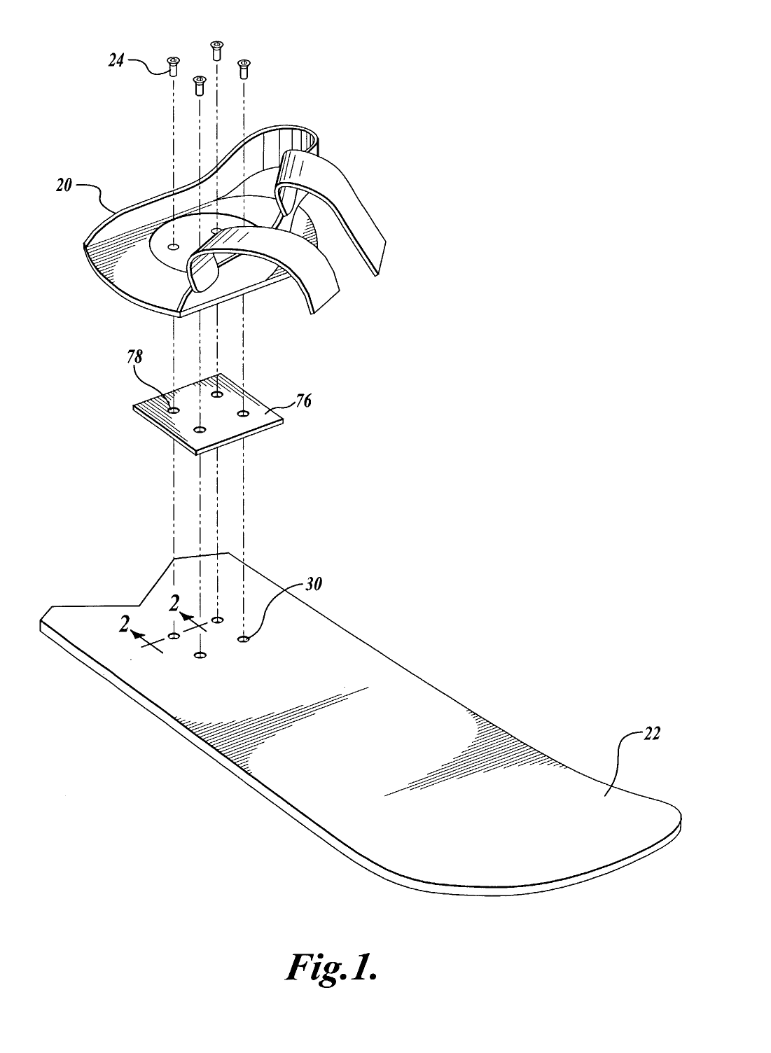

FIG. 1 illustrates an exploded view of a schematic representation of a conventional snowboard binding 20 adapted to be fixedly secured to the top surface of a snowboard 22 with threaded fasteners 24 that extend through a portion of the binding 20 and threadably engage a plurality of inserts 30 of the binding insert suspension system affixed within the snowboard 22. Generally described, once the binding 20 is fixedly secured to the snowboard 22, the binding insert suspension system provides a selected amount of dampened vertical travel between the snowboard 22 and the binding 20 for absorbing vibration when riding hard-packed surfaces, and for providing shock absorption when riding over jumps, half pipes, and other terrain.

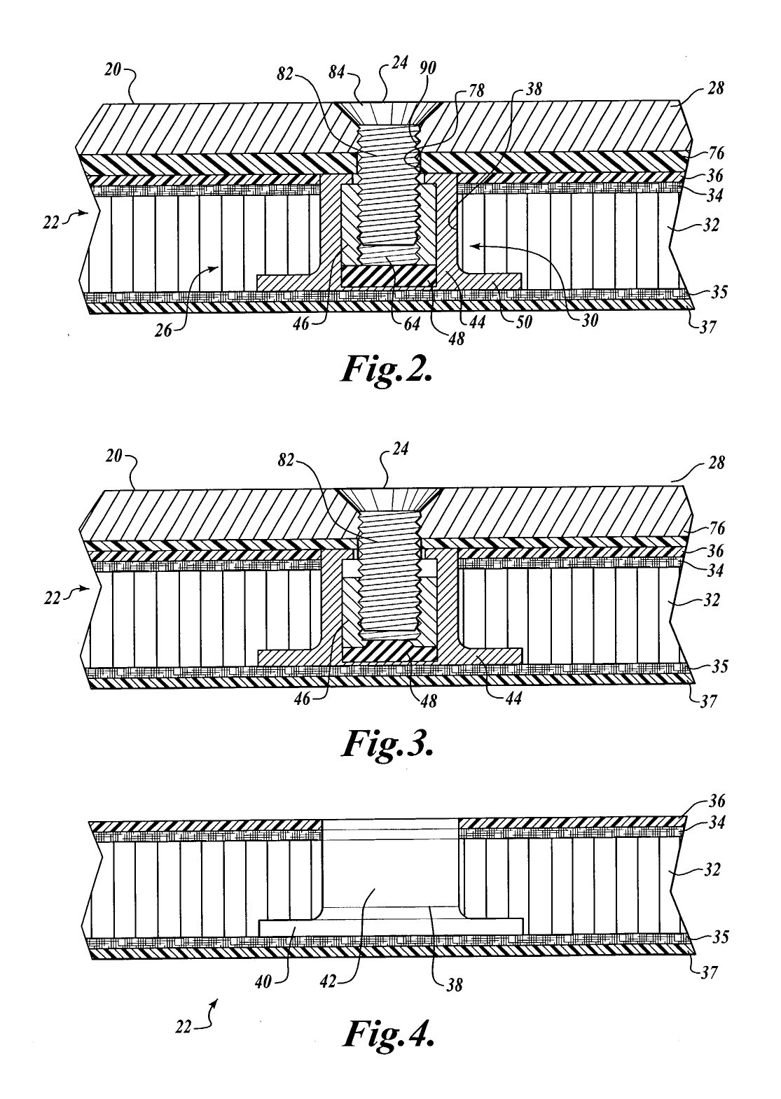

One suitable embodiment of a binding insert suspension system 26 (“the suspension system 26”) constructed in accordance with aspects of the present invention is illustrated in FIG. 2. FIG. 2 is a partial cross-sectional side view of the bottom 28, such as a base plate or disk, of a conventional snowboard binding 20 fixedly secured to the top surface of the snowboard 22 by the suspension system 26. The suspension system 26 includes at least a compressible layer 76 disposed between the binding 20 and the snowboard 22, and at least one insert 30 adhered to or otherwise affixed within the snowboard 22. The insert 30 is adapted for receiving one of the threaded fasteners 24 in threaded engagement.

Prior to a detailed description of the suspension system, one type of glide board, such as snowboard 22, configured to receive the insert 30 will be described in detail. As best shown in FIG. 4, the snowboard 22 includes at least a core 32 disposed between top and bottom structure layers 34 and 35. The core 32 and structural layers 34 and 35 are sandwiched between a top surface layer 36 attached to the top structure layer 34, and a bottom layer or gliding surface 37 attached to the bottom structure layer 35. The snowboard 22 may include other components, which are not shown for ease of illustration but are well known in the art. As known in the snowboard art, the core 32 may be constructed of wood or structural foam. The top and bottom structural layers 34 and 35 may be constructed of a suitable material, such as fiberglass. The top surface layer 36 may be constructed of a suitable material, such as ABS or nylon, and the gliding surface 37 may be constructed of a type of plastic material generally referred to as P-Tex.

The snowboard 22 includes a plurality of countersunk bores 38 (only one is shown in FIG. 4) each for receiving one insert assembly. The plurality of countersunk bores 38 may be arranged to accept different types of bindings and to allow for adjustment in the positioning of such bindings. Each bore 38 includes a head region 40 opening through the bottom of the core 32 and a shaft region 42 smaller in cross-sectional area than the head region 40 extending upward therefrom and opening out of the top layer 36. The head region 40 may be configured to have a variety of different geometric shapes, such as hexagonal, octagonal, or oval, to name a few, which corresponds with a bottom flange of the insert to prohibit rotation of the insert assembly within the bore 38. Alternatively, the head region 40 may be configured with a slot such that the bottom flange of the insert is keyed to the head region 40 to prohibit rotation of the insert assembly within the bore 38.

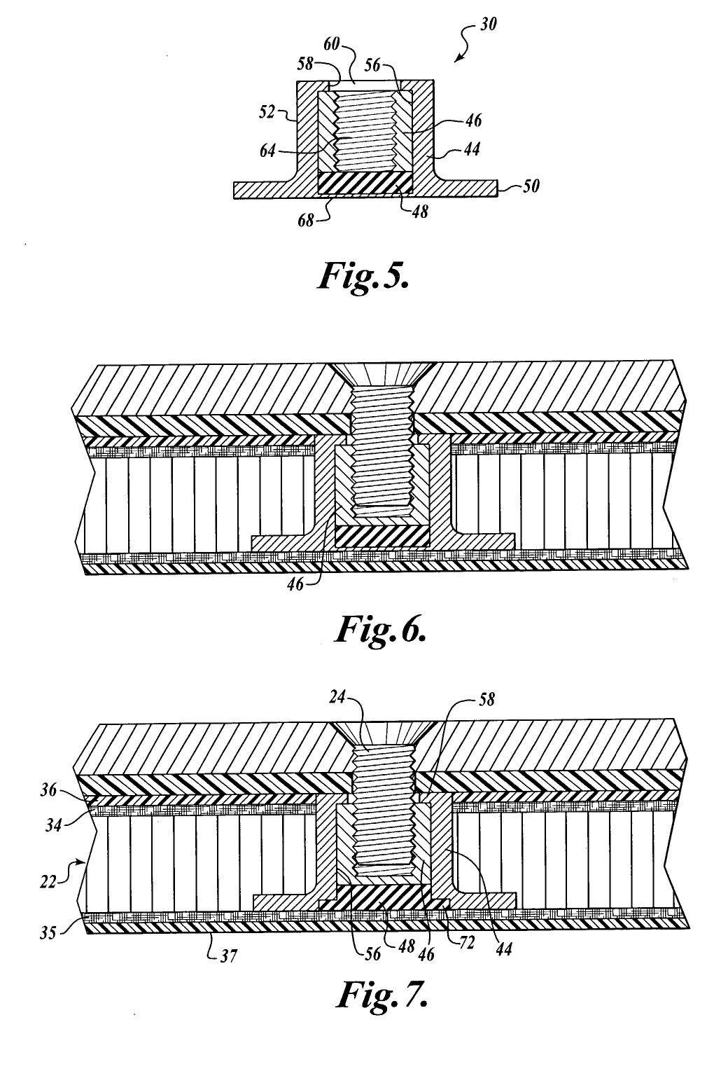

The components of the suspension system will now be described in turn. Turning now to FIG. 5, there is shown a cross-sectional side view of the insert 30. The insert 30 includes an outer insert member 44, an inner insert member 46, and an optional dampener 48. The outer insert member 44 has a bottom flange 50 and a vertically bored collar 52 projecting orthogonally upward from the center of the bottom flange 50. The vertically bored collar 52 forms a cavity 56 adapted for receiving the inner insert member 46 in sliding engagement, as will be described in more detail below. In the embodiment shown, the end of the collar 52 remote from the bottom flange 50 includes an inwardly extending lip section 58. The lip section 58 defines an opening 60, which is connected to the cavity 56 and adapted for receiving the threaded fastener. The outer perimeter of the collar 52 is configured to cooperatively seat within the snowboard bore and preferably has a circular or oval cross-section. The outer perimeter of the outer insert member 44 may be knurled, and/or the flange may be configured with a ridge or with various geometric shapes, such as hexagonal, octagonal, and oval, to name a few, to cooperate with the configuration of the recessed head region of the bore to prohibit rotation of the outer insert member 44 with respect to the snowboard.

Still referring to FIG. 5, the insert 30 further includes an inner insert member 46, preferably metallic, slidably disposed within the cavity 56. The outer perimeter of the inner insert 44 is preferably sized and configured to slidably seat within the cavity 56, and is prevented from rotation about the longitudinal axis of the cavity. To prevent rotation, the inner insert member 46 may have a serrated or splined outer surface keyed to the cooperatively shaped cavity 56. Alternatively, the outer perimeter of the inner insert member 46 may be formed with various geometric configurations, such as hexagonal, octagonal, square, to name a few, and keyed to the cooperatively shaped outer insert cavity 56. As such, the interface between the inner insert member 46 and the inner surface of the outer insert member 44 provides a rotational lock, but allows vertical sliding or translation of the inner insert member 46 with respect to the outer insert member 44. The inner insert member 46 defines a vertically aligned internally threaded bore 64 for receiving the cooperating threads of the threaded fastener, as will be described in more detail below. In the embodiment shown in FIG. 5, the inner insert member 46 has an open bottom end; however, it will be appreciated that the inner insert 46 may be formed with a closed bottom end, as shown best in FIG. 6.

The insert 30 further includes an optional dampener 48 sized and configured to be received within the cavity 56, as shown in FIG. 5. The dampener 48 may be a layer constructed out of any suitable material having viscoelastic properties, such as rubber or polyurethane. As will be readily apparent, the material selected for the dampener 48 may have a range of stiffness or durometer hardness values depending on rider preferences. In one embodiment, the stiffness of the dampener 48 is such that it supports the inner insert member in the uncompressed state, but does not offer substantial resistance to compression when force is applied thereto during use. The thickness of the dampener 48 is selected such that together with the height of the inner insert member 46 equals the height of the cavity 56. When assembled, the bottom of the inner insert member 46 rests upon the top of the dampener 48, which in turn is supported by a bottom wall 68 of the bottom flange 50. Alternatively, the dampener 48 may be supported by the bottom structural layer 36 of the snowboard 22, as shown in FIG. 7. In the embodiment of FIG. 7, the dampener 48 may be constructed in the form of the plug having an oversized flange 72, which prevents debris or adhesive from entering the cavity 56 during the fabricating process. In either case, the top surface of the inner insert member 46 engages against and is retained therein by the lip portion 58. Alternatively, the lip portion 58 may be omitted so that inner insert member 46 is retained by either the top structural layer 34 or the top surface layer 36. In either case, the dimensions of the outer insert member 44 would be adjusted accordingly. When a force is applied to the inner insert member 46 by the threadable fastener 24, the inner insert member 46 translates within the cavity 56 of the outer insert member 44, thereby compressing the dampener 48. During translation, the dampener 46 absorbs vibrations and shock supplied thereto.

When installed in the snowboard, as best shown in FIG. 2, the insert 30 is inserted into the suitably configured and sized bore 38 of the snowboard core 32 such that the collar 52 and flange 50 are seated therein. When seated in the bore 38, the top surface of the collar 52 is flush with or slightly below the top surface of the snowboard 22, the bottom flange 50 is flush with the bottom surface of the snowboard core 32, and the longitudinal axis of the insert 30 is substantially orthogonal to the longitudinal axis of the snowboard 22. As will be apparent, the bottom flange 50 prevents the outer insert member 44 from being pulled out of the top of the snowboard 22 during use. After the insert 30 is inserted in the bore 38, resin soaked fiberglass (not shown) is wrapped around the board to affix the insert 30 to the core 32. Alternatively, an adhesive, such as epoxy or cement, may be applied to the bore 38 prior to or after insertion of the insert 30. In either case, the top and bottom structural layers 34 and 35 are affixed to the core 32, and the top surface layer 36 and the gliding surface 37 are attached to the top and bottom structural layers 34 and 35, respectively, by methods know in the art. The insert 30 may also be installed into used snowboards of users wanting the benefits of the suspension system 26. In these embodiments, after the bottom structural layer and the original insert have been removed, an insert 30 of the present invention is inserted into the bore of the core. After insertion, adhesive, such as epoxy, is added to the bore to harden around the flange. Thereafter, the original, or if needed, a new bottom structural layer is affixed to the core. It will be appreciated that other methods of fixedly attaching the insert 30 to the snowboard 22 may be practiced with the present invention.

Referring back to FIGS. 1 and 2, the suspension system 26 further includes a compressible layer 76. The compressible layer 76 is disposed between the bottom 28 of the binding 20 and the top surface layer 36 of the snowboard 22. In the embodiment shown, the compressible layer 76 includes one aperture 78 for each bore 38 of the snowboard. The apertures 78 are aligned and preferably coaxial with the threaded bore 64 of the inner insert member 46 and the bore 38 of the snowboard 22. Alternatively, the aperture 78 may be oversized or formed in the shape of a slot to provide access to more than one bore 38 of the snowboard. This configuration can provide the rider with the ability to adjust the positioning of his/her binding with respect to the snowboard 22 while still utilizing the same insert locations. The compressible layer 76 may be fastened to the top surface of the snowboard 22 by any known mechanical or chemical methods, such as fasteners or adhesive, to name a few. Alternatively, the layer 76 may be held in place by the clamping force between the binding 20 and the snowboard 22 when the threaded fastener 24 is secured to the insert 30. The compressible layer 76 is suitably formed from an elastomeric material that is capable of absorbing shock and vibration, as well as for providing frictional contact with the snowboard binding. As such, the compressible layer 76 may be referred to as a dampening layer. During use, force applied to either the binding 20 or the snowboard 22 compresses the compressible layer 76 from its non-compressed state to a compressed state. While the compressible layer 76 is shown herein as a pad with at least one or a plurality of apertures 78, it will be appreciated that the compressible layer 76 may be configured as separate components located around each of the bores 38 of the snowboard 22.

It will be readily apparent that the durometer hardness and spring constant of the compressible layer 76 may be selected for a desired degree of dampening and/or a desired total distance of travel. In one embodiment, the durometer hardness value, the spring constant, or the amount of energy absorption of the layer 76 is equal to that of the dampener 48. In other embodiments, the durometer value and spring constant of the layer 76 are greater than the dampener 48, that is, the layer 76 requires a larger force to be compressed than the dampener 48. In the embodiment where the compressible layer 76 is held in place by the clamping force between the binding and the snowboard, multiple compressible layers or pads of differing durometer hardness and/or thicknesses may be provided in a kit, so that a user may completely replace or interchange one compressible layer with alternate compressible layers for either a greater degree of dampening, lesser degree of dampening, or to provide a greater or lesser total height. It will be appreciated that the compressible layer may be supplied with the board, either affixed thereto or separate from the board. Additionally, the compressible layer may be supplied or sold separately from the snowboard. For example, single layers or a kit of multiple layers may be available having different compressibility characteristics. Further, it will be appreciated that the bindings used with the embodiments herein may either be retrofitted or initially configured to have a compressible layer affixed to or integral with its bottom surface. Accordingly, it will be appreciated that all of these configurations are embodiments of the present invention, and thus, are within the scope of the present invention.

As was described above with reference to FIG. 2, threaded fasteners 24 fixedly secure the binding 20 to the snowboard 22. Each threaded fastener 24 includes an externally threaded shank 82 and a head portion 84 at one end. The threaded fastener 24 extends into a suitably sized and configured aperture 90 in the bottom 28 of the binding. The bottom aperture 90 is preferably countersunk so that the head portion 84 of the threaded fastener 24 is flush with its top surface. In the embodiment shown, the aperture 90 in the bottom 28 is internally threaded with threads below the countersink that cooperate with the exterior threads of the threaded fastener 24. Thus, when assembled, the threaded screw 24 and the bottom of the binding form a positive connection and translate as one integral member. The threaded screw 24 extends through the compressible layer aperture 78 so that the external threaded shank 82 engages the internally threaded bore 64 of the inner insert 46.

To fixedly secure the bottom 28 of the binding 20 to the snowboard 22, the binding 20 is placed over the compressible layer 76 such that its aperture 90 is aligned with the compressible layer aperture 78 and the internally threaded bore 64 of the inner insert member 46. The threaded fastener 24 is then aligned with the apertures 78 and 90 and rotated in a conventional manner so that the external threaded shank 82 of the threaded fastener 24 engages first with the internal threads of the bottom aperture 90, and then with the internally threaded bore 64 of the inner insert 46.

The operation of the binding system will now be described with reference to FIGS. 2 and 3. FIG. 2 is a partial cross-sectional side view of the binding 20 secured to the snowboard 22 where the suspension system 26 in an uncompressed state. In the uncompressed state, i.e., when approximately zero forces are applied to either the binding or the snowboard, the compressible layer 76 located between the binding 20 and the snowboard 22 and the optional dampener 48 disposed in the cavity 56 of the outer insert member 44 are at their at rest or uncompressed thicknesses. The bottom of the inner insert member 46 is supported by the dampener 48 and the top of the inner insert member 46 abuts against the lip section 58. The threaded fastener 24 is threadably engaged with the threads of the inner insert bore 64 and the binding aperture 90 so that they move as one integral member.

When a force is exerted on the snowboard 22, for example, from the ground surface, the force is generally transferred to the rider through the binding 20. This force, which can be from reactions from small bumps in the terrain, or from landing a jump, compresses the compressible layer 76 disposed between the binding 20 and the snowboard 20 as best shown in FIG. 3. The compression of compressible layer 76, in turn, causes the threaded fastener 24 to translate, together with the bottom 28 of the binding 20, along the vertical axis of the snowboard 22. As the threaded fastener 24 and the binding 20 translate downward toward the snowboard 22 due to the compression of the compressible layer 76, the inner insert member 46, which is threadably secure to the threaded fastener 24, exerts a force against and thereby compresses the dampener 48. Thus, during use, the binding insert suspension system 26 provides a selected amount of dampened vertical travel between the snowboard 22 and the binding 20 for absorbing vibration when riding hard-packed surfaces, and for providing shock absorption when riding over jumps, half pipes, and other terrain.

While the positive connection formed between the threaded fastener 24 and the binding 20 has been described above and illustrated herein as a threaded connection, it will be appreciated that there are other methods of forming a positive connection between the threaded fastener 24 and the binding 20 so that they translate as one integral member. For example, the threaded fastener 24 may be retained in a captured track formed in the bottom of the binding 20. Alternatively, the threaded fastener 24 could be secured to the binding 20 by external means, such as a cap or a lever, after securement of the binding to the snowboard.

Additionally, it will be appreciated that the amount of translation of the inner insert member 46 is determined by the characteristics of the layer 76 and the dampener 48, such as thickness, hardness and spring constant values, and materials, to name a few. The layer 76 and the dampener 48 work cooperatively, and thus, compress the same vertical distance. It will be appreciated that during the movement of the threaded fastener 24, the head section 84 remains flush with the bottom 28 do to the positive connection between the respected threaded surfaces of the threaded shaft 82 and the threaded aperture 90.

FIG. 9 is an alternative embodiment of a binding insert suspension system 126 in accordance with the present invention. The suspension system 126 is substantially identical in construction, material, and operation as the suspension system 26 described above except for the differences that will now be described. FIG. 9 illustrates a partial cross-sectional side view of the bottom 128, such as a base plate or disk, of a conventional snowboard binding 120 fixedly secured to the top surface of the snowboard 122 by the suspension system 126. The suspension system 126 includes at least a compressible layer 176 disposed between the binding 120 and the snowboard 122, and at least one insert 130 adhered to or otherwise affixed within the snowboard 122. The insert 130 is adapted for receiving the threaded fastener 124 in threaded engagement.

The insert 130 of the suspension system 126 includes an inner insert member 146 slidably received but prevented to rotate within a cavity 152. An optional dampener 148 is disposed within the cavity and abuts against the bottom of the inner insert member 146. A biasing member 194, such as a spring, is also disposed within the cavity 152 and abuts against the top of the inner insert member 146 and an overhead lip section 158 formed at the top the cavity 152. The biasing member 194 is preloaded to exert a force against the top of the inner insert member 146.

In operation, when the compressible layer 176 compresses and the binding 120 translates toward the snowboard 122, the threaded fastener 124 translates with the binding 120 due to the sufficient biasing force of the biasing member 194 against the inner insert member 146. Since the biasing member 194 maintains the threaded fastener 124 flush with the bottom 128 of the binding 120, the binding aperture 190 does not need to be threaded. Thus, the inner insert member 146 is allowed to translate downward and compress the dampener 148. It will be appreciated the dampener 148 may be omitted, if desired.

Another alternative embodiment of a binding insert suspension system 226 according to the present invention is shown in FIG. 10. The suspension system 226 is substantially identical in construction, material, and operation as the suspension system 26 described above except for the differences that will now be described. FIG. 10 is a partial cross-sectional side view of a bottom 228, such as a base plate or disk, of a conventional snowboard binding 220 fixedly secured to the top surface of a snowboard 222 by the suspension system 226. The suspension system 226 includes at least a compressible layer 276 disposed between the binding 220 and the snowboard 222, and at least one insert 230 adhered to or otherwise affixed within the snowboard 222 and adapted for receiving a threaded fastener 224 in threaded engagement. In the insert assembly 230 of this embodiment, the dampener 48 shown in FIG. 2 has been omitted. Thus, the inner insert member 246 is free to translate within the outer insert member 244 without any resistance thereagainst.

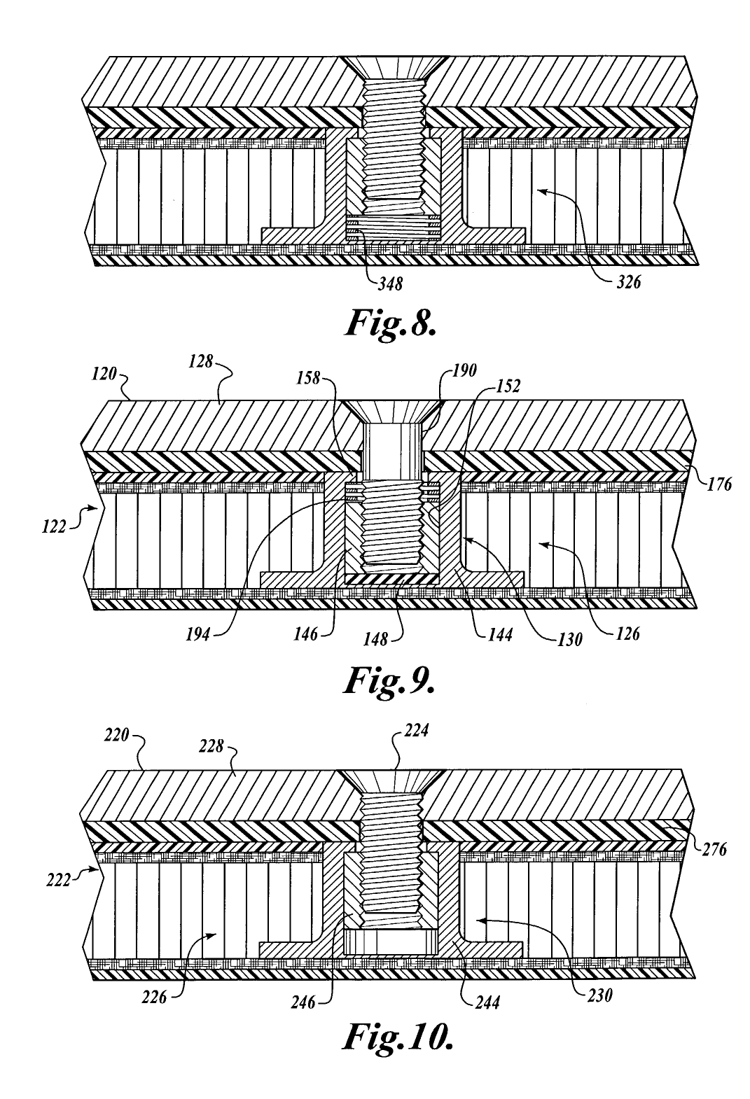

The present invention has been described thus far with reference to elastomeric or polymeric dampeners (the compressible layer 76, 176, 276 and the dampener 48, 148). However, other types of dampeners, including springs, belleville washers or dampeners with integrated springs or hydraulic fluid dampening may alternately be used. An embodiment of a suspension system 326 wherein the dampener 348 is a spring is illustrated in FIG. 8.

It will be appreciated that in embodiments where the binding is attached to the snowboard with the use of a disk, the screw apertures of the disk may be retrofitted with threads by either inserting a plug having internal threads or tapping the apertures with a conventional threaded die. Alternatively, a separate compatible disk with threaded apertures may be provided with either the binding, the snowboard, or separately like the compressible layer described above. In embodiments where the binding is attached to the snowboard without the use of a disk, the screw apertures of the bindings may be retrofitted with threads in the same manner just described. In the cases where the plug is utilized, it will be appreciated that corresponding diameter screws may be provided with the plugs. Alternatively, the plugs and screws may be provided with the snowboard or with the insert assembly as a kit.

While the embodiments of the suspension system described above and illustrated herein have been shown with snowboard bindings that include boot securement straps, it should be readily evident that the invention is equally applicable to use on other types of bindings, such as step-in bindings. One suitable but non-limiting example of a step-in binding with which the present invention may be used is the CLICKER™ binding sold by K-2 Corporation, Vashon Island, Wash. Such step in bindings are more fully described in U.S. Pat. No. 5,690,350 to Turner, which is hereby expressly incorporated by reference. Similarly, use of the suspension systems of the present invention is not limited to bindings that include rotary discs for adjustable positioning of the baseplate, and thus may be used with stationary or otherwise adjustable base plates or frames.

While the preferred embodiments of the invention has been illustrated and described, it will be appreciated that various changes can be made therein without departing from the spirit and scope of the invention.

1. An insert for a glide board to receive a binding fastener, the glide board having a lower surface, the insert comprising:
an outer member to be mounted within the glide board, the outer member including a cavity; and
an inner member disposed within the cavity, the inner member being movable within the cavity about an axis substantially transverse to the lower surface of the glide board while the glide board is in use, the inner member configured to receive a binding fastener.

2. The insert of claim 1, wherein the outer member includes an opening connected to the cavity for permitting access thereto, the opening adapted for receiving the binding fastener.

3. The insert of claim 2, wherein the opening has a cross-sectional area smaller than the cavity, the inner member slidably retained within the cavity by a portion of the outer member surrounding the opening.

4. The insert of claim 1, wherein the inner member is slidably seated within the cavity for translation along the axis substantially transverse to the lower surface of the glide board while the glide board is in use.

5. The insert of claim 1, wherein the inner member is configured to cooperate with the cavity so as to inhibit rotation of the inner member with respect to the outer member.

6. The insert of claim 1, wherein the inner member has an internally threaded bore for receiving the binding fastener in removable securement.

7. The insert of claim 1, further including a dampener having a spring constant, the dampener being disposed within the cavity of the outer member and compressible between an uncompressed state and a compressed state.

8. The insert of claim 7, wherein the dampener abuts against a bottom end of the inner member, the dampener being compressible for allowing the inner member to translate within the cavity.

9. The insert of claim 8, further comprising a biasing member having a spring constant, the biasing member being disposed within the cavity and exerting a biasing force against a top end of the inner member.

10. The insert of claim 9, wherein the spring constant of the dampener is less than or equal to the spring constant of the biasing member.

11. The insert of claim 7, wherein the dampener is selected from a group consisting of a spring, an elastomeric layer, and a belleville washer.

12. The insert of claim 7, further comprising a biasing member disposed within the cavity and exerting a biasing force against a top end of the inner member.

13. A glide board to which a binding is removably secured by at least one binding fastener, comprising:
a core disposed between top and bottom layers, the glide board having at least one bore that extends through the core and forms an opening in the top layer, the opening configured for receiving the binding fastener therein;
an outer insert member disposed within the bore and coupled to at least the core, the outer insert member having a top end and defining a cavity; and
an inner insert member disposed within the cavity of the outer insert member, the inner insert member being movable within the cavity for translation along an axis substantially transverse to the longitudinal axis of the glide board, the inner insert member configured for receiving the binding fastener in removable securement.

14. The glide board of claim 13, further comprising a dampener disposed within the cavity of the outer insert member and abutting against a bottom end of the inner insert member, the dampener compressible between an uncompressed state and a compressed state for allowing the inner insert member to move within the cavity.

15. The glide board of claim 14, further comprising a compressible layer overlaying a portion of the top layer of the glide board and having an aperture disposed therethrough in substantial alignment with the inner insert member for passing the binding fastener therethrough.

16. The glide board of claim 15, wherein the compressible layer is less compressible than the dampener.

17. The glide board of claim 14, wherein the dampener is selected from a group consisting of a spring and an elastomeric layer.

18. The glide board of claim 13, further comprising a compressible layer overlaying a portion of the top layer of the glide board and having an aperture disposed therethrough in substantial alignment with the inner insert member for passing the binding fastener therethrough.

19. The glide board of claim 13, further comprising a biasing member having a spring constant disposed within the cavity and exerting a biasing force against a top of the inner insert member.

20. In a glide board of the type to which a binding is removably secured thereto by at least one binding fastener, the binding fastener adapted for translation with the binding, the glide board having a core disposed between top and bottom layers, at least one bore that extends into the core and opens out of the top layer, and a binding insert suspension system, the suspension system comprising:
a compressible layer disposed between the glide board and the binding, the compressible layer having at least one aperture in substantial alignment with the bore and adapted for receiving the binding fastener; and
an insert affixed within the bore of the glide board, the insert including:
(a) an outer insert member including a cavity; and
(b) an inner insert member disposed within the cavity of the outer insert member, the inner insert member movable within the cavity for translation along an axis transverse to the longitudinal axis of the glide board.

21. The suspension system of claim 20, further comprising a dampener disposed within the cavity and abutting against a bottom end of the inner insert member, the dampener compressible between an uncompressed state and a compressed state for allowing the inner insert member to translate within the cavity.

22. The suspension system of claim 21, wherein the dampener is selected from a group consisting of a spring and an elastomeric layer.

23. The suspension system of claim 21, further comprising a biasing member disposed within the cavity and exerting a biasing force against a top end of the inner insert member.

24. The suspension system of claim 20, further comprising a biasing member disposed within the cavity and exerting a biasing force against a top end of the inner insert member.

25. A glide board having a top surface comprising:
at least one bore opening at the top surface, the opening configured for receiving a binding fastener therein;
an outer insert member disposed within the bore, the outer insert member including a cavity and an opening formed by a lip section for permitting access to the cavity;
an inner insert member disposed within the cavity and keyed thereto for permitting translation within the cavity but inhibiting rotation of the inner insert member with respect to the outer insert member, the inner insert member configured to receive the binding fastener; and
a biasing member disposed within the outer insert member cavity and exerting a biasing force against a top end of the inner insert member and the lip section of the outer insert member.

26. The glide board of claim 25, further comprising a compressible member positioned on the top surface of the glide board, the compressible layer having at least one aperture in substantial alignment with the bore and adapted for receiving the binding fastener.

27. The glide board of claim 25, further comprising a dampener disposed within the cavity and abutting against a bottom end of the inner insert member, the dampener compressible between an uncompressed state and a compressed state for allowing the inner insert member to translate within the cavity.

28. The glide board of claim 27, further comprising a compressible member mounted on the top surface of the glide board, the compressible layer having at least one aperture in substantial alignment with the bore and adapted for receiving the binding fastener.
